(19) United States
(12) Patent Application Publication
(10) Pub. No.: US 2022/0412461 A1
(43) Pub. Date: Dec. 29, 2022

(54) Stuffing Box Assembly

(71) Applicant: Jason Pitcher, Spring, TX (US)

(72) Inventor: Jason Pitcher, Spring, TX (US)

(21) Appl. No.: 17/361,608

(22) Filed: Jun. 29, 2021

(51) Int. Cl. F16J 15/16; F16J 15/26

(52) U.S. Cl. CPC F16J 15/164; F16J 15/26

(57) ABSTRACT

A stuffing box assembly having a body and a bore therethrough. Disposed in the body in surrounding relationship to the bore are first and second axially displaced annular seals, a detection zone being formed between the first and second seals. There is an injection port in open communication with the detection zone and a pressure transducer operatively connected to the detection zone to determine pressure changes in the detection zone.

### FIELD OF THE INVENTION

The present invention relates to stuffing boxes for moving shafts, e.g., reciprocating shafts and, more particularly, a stuffing box assembly which can be monitored for sealing integrity.

### BACKGROUND OF THE INVENTION

Stuffing boxes are widely used in industrial machinery where it is desired to form a seal, between a housing and a rotating or reciprocating shaft. One example of the use of stuffing boxes is in wellhead assemblies for beam pump production wells to prevent leakage of fluids from the well into the atmosphere. As is well known to those in the art, in these wellhead assemblies, a polished rod reciprocates in the stuffing box, a stack of annular seal rings or seals being used to seal between the polished rod and the housing of the stuffing box to prevent leakage of fluids. As is known, the friction generated by a polished rod, however well machined, through the seals produces heat. This heat contributes to the deterioration of the seals and the polished rod.

Typical stuffing boxes, including those used in wellhead assemblies include first and second axially displaced seals between which is disposed a lantern ring, the lantern ring providing an inlet for lubricating the rod and the seals.

With time, the seals or seal stack in the stuffing box wear and eventually have to be replaced. However, in the interim, a gland can be adjusted to increase the compression of the seal stack and therefore minimize leakage.

However, it would be desirable to have a stuffing box assembly in which seal integrity could be monitored so as to provide workers with information as to when a packing gland needs to be tightened or whether the seal and/or polished rod have worn to the point where they must be replaced.

### SUMMARY OF THE INVENTION

In one aspect the present invention relates to a stuffing box assembly for use with movable shafts, e.g., reciprocating or rotating shafts.

In another aspect, the present invention relates to a stuffing box assembly wherein the integrity of the sealing in the stuffing box can be monitored.

In yet a further aspect, the present invention relates to a method for monitoring the integrity of a seal in a stuffing box.

These and further features and advantages of the present invention will become apparent from the following detailed description, wherein reference is made to the figures in the accompanying drawings.

### BRIEF DESCRIPTION OF THE DRAWINGS

FIG. 1 is an elevational view, partly in section, of one embodiment of the stuffing box assembly of the present invention.

FIG. 2 is a cross-sectional view taken along the lines 2-2 of FIG. 1.

FIG. 3 is a schematic view of a system for monitoring pressure and controlling a pump for injection of lubricant into the stuffing box assembly of FIG. 1.

### DETAILED DESCRIPTION OF PREFERRED EMBODIMENTS

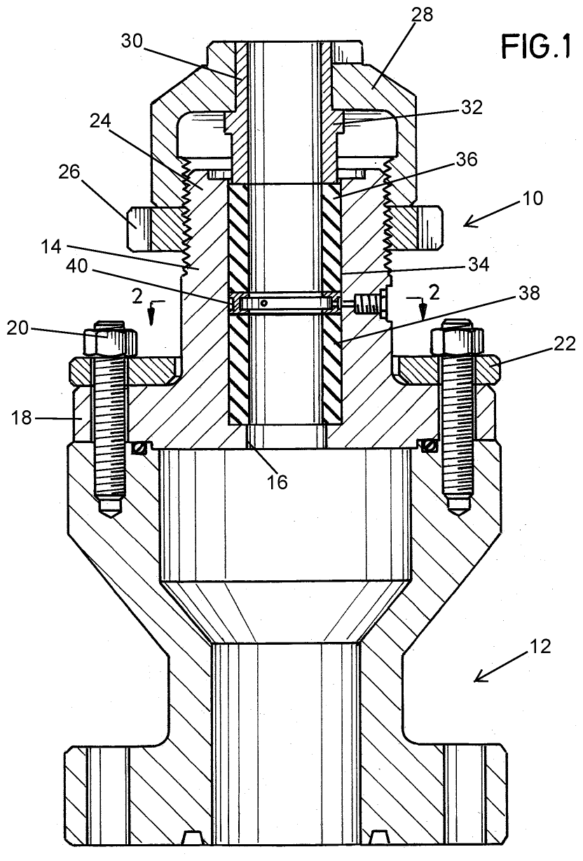

Referring first to FIG. 1, one embodiment of the stuffing box assembly of the present invention is shown generally as 10, stuffing box 10 connected to a wellhead adapter shown generally as 12. Stuffing box assembly 10 comprises a stuffing box body 14 having a bore 16 extending therethrough. Body 14 includes an annular flange 18 via which circumferentially spaced bolts 20 can be used to connected body 14 to wellhead adapter 12. In this regard, there is a keeper ring 22 sandwiched between the heads of bolts 20 and flange 18.

Body 14 has an externally threaded neck portion 24 on which is threadedly received a stop nut 26. Also threadedly received on threaded neck portion 24 is a threaded gland nut 28. There is a gland follower 30 which has an external annular rib 32 formed thereon, rib 32 being engaged by gland nut 28 when gland nut 28 is rotated so as to apply a force against annular rib 32 and hence gland follower 30.

There is a counterbore 34 formed internally of body 14 and in surrounding relationship to bore 16, counterbore 34 serving as an annular pocket for a seal stack comprised of an upper seal stack 36 and a lower seal stack 38. Disposed between upper seal stack 36 and lower seal stack 38 is a lantern ring 40. Lantern ring 40 is of conventional design and has a plurality of circumferentially spaced ports 42. Although as shown the upper and lower seal stacks 36 and 38 are each shown as unitary seal members, it will be appreciated that this is for depiction only and that in the normal case, as understood by those skilled in the art, the seal stacks would each comprise a plurality of seal rings or packing rings such as chevron rings, etc.

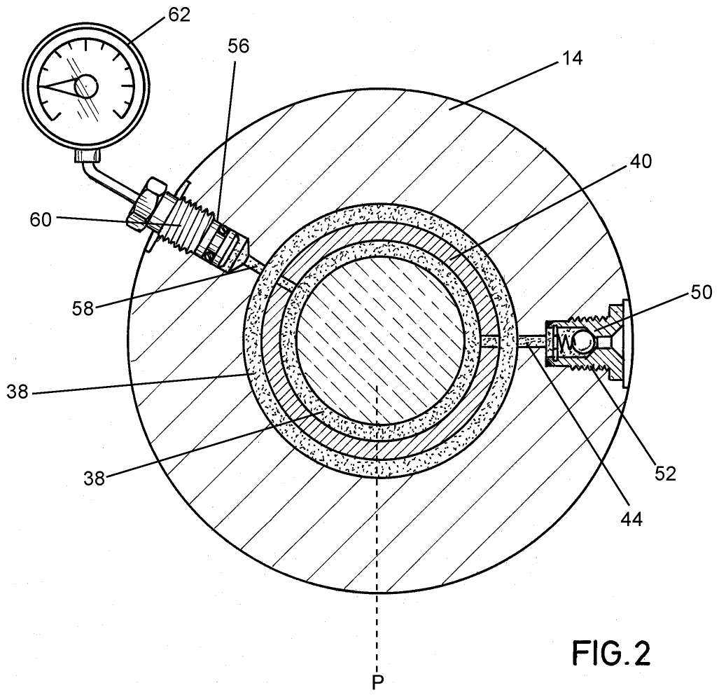

As shown in FIG. 2, a polished rod P (shown in phantom) extends through the seal stack in the well-known fashion.

Referring now to FIG. 2, there is an injection passage 44 in body 14 which is in open communication with lantern ring 40. Passage 44 is also in open communication with a threaded bore 52 in body 14. Threadedly received in bore 52 is a check valve 50, check valve 50 being of the spring-loaded ball check type. Lubricant and other necessary fluids can be injected into the seal stack assemblies via a suitable pressurized injection gun, whereby the seals in the seal stack 36 and 38 can be lubricated. Lantern ring 40 defines a detection zone in the sense that the zone can be probed to monitor pressure in the zone. Such a zone could also be formed by simple spacers between the upper and lower seal stacks. In this regard, the upper and lower seal stacks 36 and 38 can, at their interface, also define a detection zone as well as an injection zone.

There is a second threaded bore 56 formed in body 14, a passage 58 being in open communication with bore 56 and lantern ring 40. Threadedly received in bore 56 is a pressure transducer 60 of conventional design, transducer 60 being connected to a pressure gauge 62 or similar pressure read out device.

In using the method according to one aspect of the present invention, grease or other lubricant would be injected into the detection zone defined by lantern ring 40 via check valve 50 resulting in a pressure build-up in the seal ring stack from the pressurized lubricant. Over time, as the sealing stacks wear, lubricant seepage occurs. This seepage reduces the pressure in the detection zone of lantern ring 40 below the pressure that was initially experienced when the lubricant was injected. Via pressure transducer 60 and pressure gauge 62, the pressure can be monitored such that when the pressure reaches a lower level or zero, it will indicate either that gland follower 30 should be compressed by rotating gland nut 28 to further compress the seal stack, or that the seal stacks have failed.

Pressure transducer 60 can be any one of several types of transducers. Thus, transducer 60 can comprise a strain gauge pressure transducer, a capacitance pressure transducer, a densiometric pressure transducer, or a resonant wire pressure transducer. Generally speaking, the transducer will be of the strain gauge type.

In the disclosed embodiment, the pressure transducer 60 is shown as being disposed in a bore 56 in the body 14 of the stuffing box 10. However, the pressure transducer can be mounted externally of body 14. Thus, and by example only, an injection plug, received in bore 52, could have a branch or T to which the pressure transducer was connected such that lubricant can both be injected through the plug into the detection zone and, as well, pressure could be determined by the pressure transducer being in open communication with the detection zone.

Strain gauge transducer operation is based on the generation of an electrical signal which can be converted into an engineering unit such as PSI or bars which can then be displayed on a suitable pressure readout device such as a gauge. However, it is to be understood that the transducer signal could be digitized and transferred remotely for offsite monitoring.

From the above it can be seen that the pressure transducer need only be operatively connected to the detection zone such that pressure changes in that zone will be reflected in a pressure transducer output regardless of whether the output was an analog or digital signal.

Though not shown, it is common for stuffing box assemblies to include a biased valve element in the wellhead adapter, the valve element moving to the closed position to close off the issuance of formation fluids should the polished rod drop into the well because of failure thereof. Thus, flapper-type valves, ball valves, or the like can be employed.

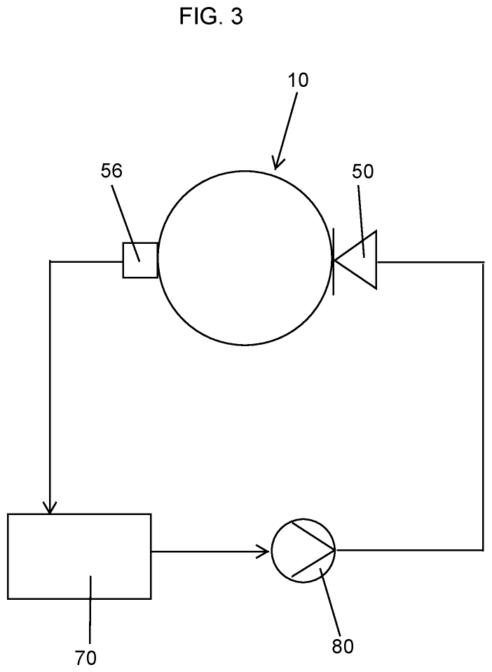

Turning now to FIG. 3, there is shown a simplified schematic of a system for monitoring pressure in the detection zone of the stuffing box 10. A microprocessor or other programmable controller 70 is configured to monitor pressure via a signal from transducer 56 and in response thereto activate a pump 80 at selected times and for selected durations based on the detected pressure as recognized by transducer 56. Accordingly, pump 80 can pump lubricant, grease, or the like from the source (not shown) into the check valve 50 connected to stuffing box assembly 10. The control system shown in FIG. 3 would also inherently detect when the pressure drop in the stuffing box assembly 10 was so great that further addition of lubricant or grease would not be sufficient either due to the polished rod, or more likely, the seal stack having worn to the point where substantially no pressure integrity could be maintained in the detection zone of stuffing box assembly 10.

Although specific embodiments of the invention have been described herein in some detail, this has been done solely for the purposes of explaining the various aspects of the invention and is not intended to limit the scope of the invention as defined in the claims which follow. Those skilled in the art will understand that the embodiment shown and described is exemplary, and various other substitutions, alterations, and modifications, including but not limited to those design alternatives specifically discussed herein, may be made in the practice of the invention without departing from its scope.

What is claimed is:

1. A stuffing box assembly, comprising:
a body having a bore therethrough;
first and second axially displaced annular seals in surrounding relationship to said bore and forming a detection zone therebetween;
an injection port in open communication with said detection zone; and
a pressure transducer operatively connected to said detection zone.

2. The assembly of claim 1, wherein said first and second seals comprise first and second stacked seal rings, respectively.

3. The assembly of claim 1, wherein there is a check valve in said injection port.

4. The assembly of claim 1, wherein said body has a bore in open communication with said detection zone and said pressure transducer is positioned in said bore.

5. The assembly of claim 1, wherein said pressure transducer is connected to a pressure readout device.

6. The assembly of claim 5, wherein said readout device is a pressure gauge.

7. A method of monitoring sealing integrity in a stuffing box wherein the stuffing box includes a body having a bore therethrough and first and second axially displaced seals forming a detection zone therebetween, said method comprising:
injecting grease into said detection zone; and
monitoring the pressure of said grease in said detection zone.

8. The method of claim 7, wherein said first and second seals comprise first and second stacked seal rings, respectively.

9. The method of claim 7, wherein said pressure is monitored using a pressure transducer.

10. The method of claim 7, wherein grease is injected into said detection zone at a first pressure, and said first pressure is monitored to determine a lower, second pressure.
